(19) United States
(12) Patent Application Publication
(10) Pub. No.: US 2017/0280679 A1
(43) Pub. Date: Oct. 5, 2017

(54) ABSORBENT DOG BED

(71) Applicant: Harley Jo Swedyk, Las Vegas, NV (US)

(72) Inventor: Harley Jo Swedyk, Las Vegas, NV (US)

(21) Appl. No.: 15/478,160

(22) Filed: Apr. 3, 2017

Related U.S. Application Data
(60) Provisional application No. 62/317,522, filed on Apr. 2, 2016.

(51) Int. Cl. A01K 13/00; A01K 1/035; A01K 1/015

(52) U.S. Cl. CPC A01K 13/001; A01K 1/0157; A01K 1/0353

(57) ABSTRACT

A pet bed may include a structure with an outer shell that is configured to wick moisture away from a wet animal. The outer shell may have hydrophobic properties that permit a horizontal flow of moisture across a surface of the outer shell and the horizontal flow of moisture may lessen a concentration of a vertical flow of moisture. The pet bed may include a first padding layer, a second padding layer, and four or more absorbing layers positioned between the first padding layer and the second padding layer.

### FIELD

The embodiments discussed herein are related to pet beds having absorbent characteristics.

### BACKGROUND

Traditional pet beds provide various levels of comfort and support for animals to relax and sleep. However, traditional pet beds do not aid in properly drying a wet animal. Wetness or moisture can arise from a bath, rainwater, shrubbery, grass, or many other sources. In such cases involving a wet animal, caretakers, owners and groomers typically do not allow the wet animal onto traditional pet beds until sufficiently dry. Instead, the caretakers, owners and groomers employ various methods that allow and/or enhance airflow to wet portions of the animal. Additionally or alternatively, these individuals may personally towel off the wet animal. If the animal is not properly dried, retained moisture may cause irritation to the animal's skin, including hot spots and/or rashes at various locations on the animal.

The subject matter claimed herein is not limited to embodiments that solve any disadvantages or that operate only in environments such as those described above. Rather, this background is only provided to illustrate one area where some embodiments described herein may be practiced.

### SUMMARY

A pet bed that may have absorbent characteristics is disclosed. An exemplary embodiment may include an outer shell and the outer shell may be configured to wick moisture away from a wet animal. The outer shell may have hydrophobic properties that permit a horizontal flow of moisture across a surface of the outer shell. The horizontal flow of moisture may lessen a concentration of a vertical flow of moisture. An exemplary embodiment may also include a first padding layer, a second padding layer, and four or more absorbing layers positioned between the first padding layer and the second padding layer.

### BRIEF DESCRIPTION OF THE DRAWINGS

Example embodiments will be described and explained with additional specificity and detail through the use of the accompanying drawings in which:

FIG. 1 illustrates an example pet bed with an outer shell and the outer shell may be configured to wick moisture away from a wet animal;

FIG. 2 illustrates a cross-section side view of an example pet bed and the pet bed may include an absorbent pad configured to absorb moisture;

FIG. 3 illustrates an example absorbent pad;

FIG. 4 illustrates a cross-section side view of an example absorbent pad and the absorbent pad may be configured to absorb moisture via absorbing layers; and

FIG. 5 illustrates a cross-section side view of an example pet bed that may be configured to wick moisture away from an animal and/or allow moisture from the animal to flow in various directions for absorption.

### DESCRIPTION OF EMBODIMENTS

Sometimes animals develop hot spots, rashes, or other skin irritations when wet fur and/or skin is not properly dried. These animals, which are in many cases people's pets, can be highly susceptible to skin irritations. This susceptibility to skin irritations can be worsened by a variety of exacerbating factors, including breed or heredity, high activity levels, environmental allergies, soap/shampoo allergies, fleas/ticks, matted fur, environmental wetness (e.g., frequent rain or precipitation or high humidity levels), skin sensitivity or dryness, and/or frequent bathing. In some instances, groomers, caretakers and/or owners may take preventative steps and/or proper care to ensure their pet does not acquire these skin irritations.

One of those preventative steps or quality care tips may involve proper drying of a wet animal. Conventional methods of properly drying the wet animal often fail to incorporate self-drying techniques (e.g., without human assistance) and may include the wet animal laying on a pet bed because conventional pet beds tend to permit moisture retention on the animal and thereby leading to skin irritations on the animal.

In contrast, these and other embodiments include a pet bed having absorbent characteristics, which may allow for moisture to be wicked away from the wet animal. In such a manner, a wet animal, which may be soaked to a maximum degree possible (e.g., having a maximum amount of retained moisture), may lay on the pet bed for a period of time. After a period of time, the animal may be sufficiently dry so as to not develop skin irritations from wetness. Indeed, after a period of time the animal may be sufficiently dry, including portions of the animal which are not exposed to ambient air but are in contact with the pet bed.

In some embodiments, the pet bed may include an outer shell that does not retain moisture but is hydrophobic in nature, thereby wicking the moisture away from the wet animal. The hydrophobic nature of the outer shell may allow for moisture to travel horizontally across some portion of the pet bed before being wicked into an inner layer, such as an absorbent pad. The absorbent pad, which may include absorbing layers within the absorbent pad, may absorb the moisture that is wicked away from the animal. As more moisture enters the absorbing layers of the absorbent pad, less and less moisture may be retained by the wet animal until the animal is sufficiently dry. These and other embodiments may allow for the drying process to occur because the absorbing layers may have an absorption capacity capable of absorbing more moisture than could possibly be held in the fur of the wet animal. In other terms, the maximum amount of moisture retention possible for the wet animal may be less than the absorption capacity of the absorbing layers within the pet bed. Furthermore, the animal may become dry and remain dry since the animal may not be exposed to the moisture after it is wicked away because the absorbing layers may be inside the pet bed and not in direct contact with the animal.

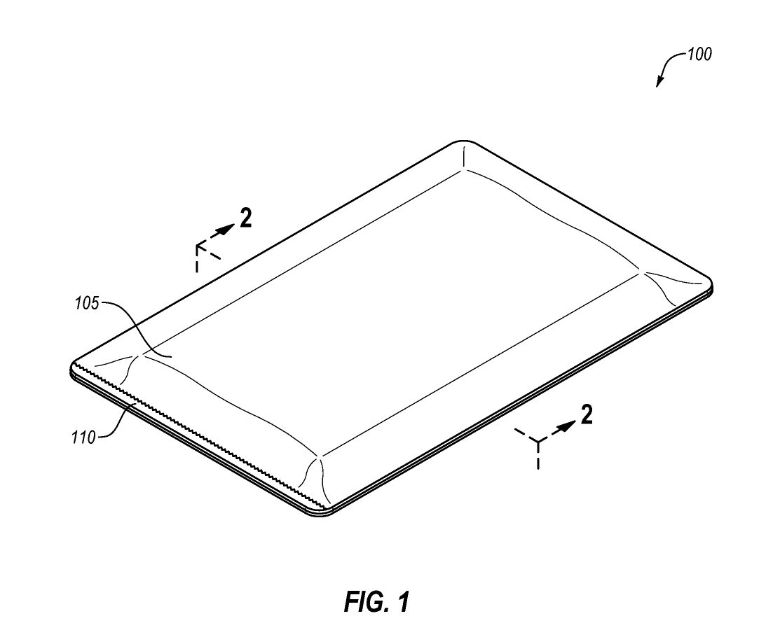

Turning to the figures, FIG. 1 illustrates an example pet bed 100 with an outer shell 105 that may be configured to wick moisture away from a wet animal. The pet bed 100 may be arranged in accordance with at least one embodiment described in the present disclosure. The pet bed 100 may include an outer shell 105 and an outer shell seam 110.

The pet bed 100 may be configured to be compatible with a size and a shape of the animal. In some embodiments, the larger the animal is, the larger the pet bed 100 may be. For example, a dog with extra-long legs may require wider/longer proportions of the pet bed 100 such that the dog fits onto the pet bed 100. Additionally or alternately, in some embodiments the pet bed 100 is compatible with a weight, a breed, and/or an amount of fur of the animal. In some embodiments, the pet bed 100 is configured to be washed and reused. For example, the pet bed 100 may be compatible with washing machines while some caretakers, owners, and/or groomers may still desire to hand wash the pet bed 100.

The outer shell 105 may be configured to wick moisture away from the animal. For example, in some embodiments the outer shell 105 may be made of a babyville wicking fabric. In other embodiments, the outer shell 105 may be made of another type of wicking fabric, e.g., synthetic fibers like polyester or polypropylene or natural fibers like merino wool. In some embodiments, the outer shell 105 may be made of fabric having hydrophobic properties. In some embodiments, the outer shell 105 may have a wicking capability that is enhanced with chemical treatments which alter hydrophobic/hydrophilic properties of the outer shell 105. Additionally or alternately, in some embodiments the wicking capability of the outer shell 105 may be enhanced using various weaves and/or knits in various combinations. In some embodiments, the outer shell 105 may also have antimicrobial/odor control properties, stain resistant properties, and/or flame resistant properties.

The outer shell seam 110 may be configured to be an external seam positioned at or at least proximate a perimeter edge of the pet bed 100. In some embodiments the outer shell seam 110 may be positioned along the perimeter edge of an end (e.g., short side or width side of a rectangle) of the pet bed 100; in other embodiments, the outer shell seam 110 may be positioned along the perimeter edge of a side (e.g., long side or length side of a rectangle) of the pet bed 100.

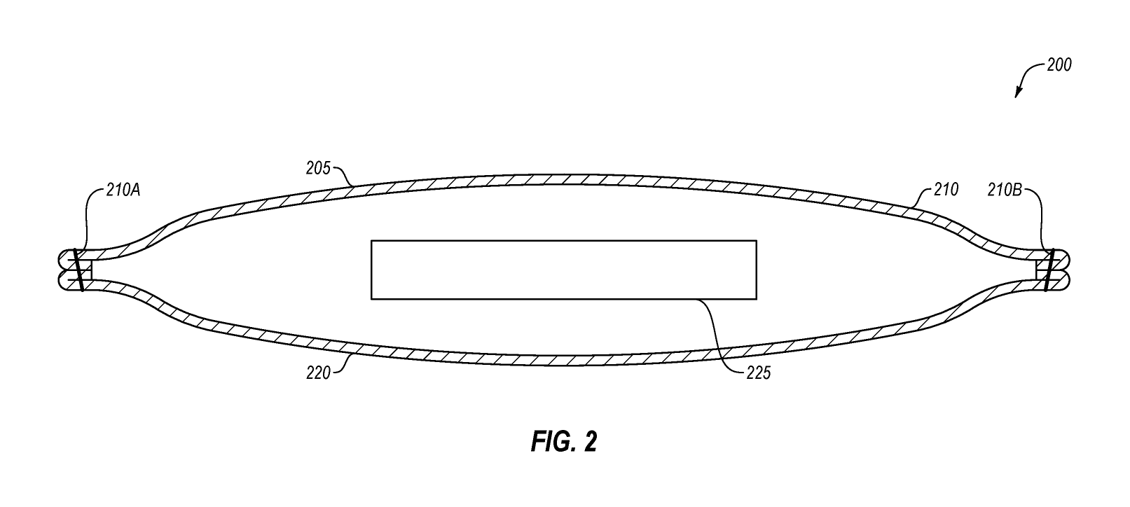

FIG. 2 illustrates a cross-section side view of an example pet bed 200 with an absorbent pad 225 configured to absorb moisture. The pet bed 200 may be arranged in accordance with at least one embodiment described in the present disclosure. The pet bed 200 may include an outer shell 205, outer shell seams 210, a top face 215 of the outer shell 205, a bottom face 220 of the outer shell 205, and/or the absorbent pad 225.

The outer shell 205 may be configured to be substantially the same as or analogous to the outer shell 105. In some embodiments, the outer shell seams 210, including 210A and 210B, may be configured to be internal seams, which run along the perimeter edge of opposing sides of the pet bed 200 in a substantially parallel fashion. In some embodiments, the outer shell seams 210 may be configured to bind together the top face 215 and the bottom face 220 of the outer shell 205.

In some embodiments, a combination of seams of the pet bed 200 may entirely or at least partially enclose the absorbent pad 225, such as via at least the outer shell seam 110 (of FIG. 1) and/or the outer shell seams 210A and 210B. In some embodiments the absorbent pad 225 may be enclosed within the outer shell 205 but is not attached in any way to the outer shell 205. In other embodiments the absorbent pad 225 may be enclosed within the outer shell 205 and may also be attached to an internal surface of the outer shell 205 via any variety of attachment means. Such attachment means may include Velcro®, hook and loop fasteners, hooks, clips, stitching, or any other means of attachment, permanent or removable, which are known to those of ordinary skill in the art. In some embodiments, the absorbing pad 225 may be enclosed within the outer shell 205 in such a way that the absorbing pad 225 and the outer shell 205 are substantially concentric, both sharing a same center point of the pet bed 200. Such concentricity may lend to more proper and even absorption of moisture in addition to a more aesthetically balanced pet bed 200.

In some embodiments, the pet bed 200 may be configured to include another seam (not shown), which is configured to be an internal/external seam located at the perimeter edge opposite of the outer shell seam 110 (of FIG. 1). In this embodiment, the other seam (not shown) may be substantially perpendicular to the outer shell seams 210. However, in other embodiments, there is no other seam located at the perimeter edge opposite of the outer shell seam 110 (of FIG. 1) where the top face 215 and the bottom face 220 of the outer shell are not separate, individual pieces of fabric, but are instead made of one continuous piece of fabric. In this embodiment, the top face 215 and the bottom face 220 are made by folding the wicking fabric onto itself such that the fold is positioned at an opposite side of the outer shell seam 110 (of FIG. 1). In this manner, the fold and the outer shell seam 110 (of FIG. 1) are substantially parallel relative to each other.

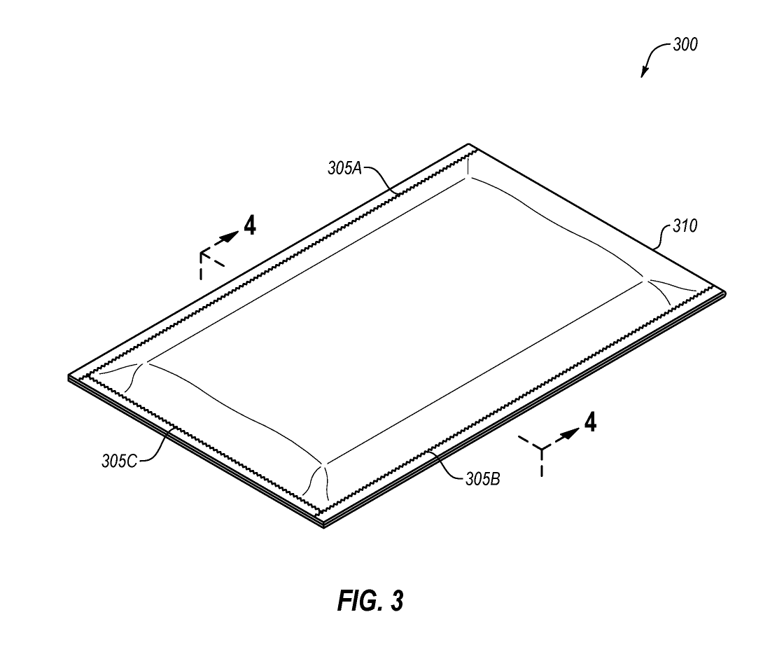

FIG. 3 illustrates an example absorbent pad 300 that may include seams 305. The absorbent pad 300 may be configured to be substantially the same as or analogous to the absorbent pad 225.

The seams 305, which may include seams 305A, 305B, and 305C, may be configured to be an external seam positioned at a perimeter edge of the absorbent pad 300. In some embodiments, seam 305C may be positioned along the perimeter edge of an end (e.g., short side or width side of a rectangle) of the absorbent pad 300. In some embodiments, seams 305A and 305B may be positioned along the perimeter edge of a side (e.g., long side or length side of a rectangle) of the absorbent pad 300. In these embodiments, seams 305A and 305B may be substantially perpendicular to seam 305C; and seams 305A and 305B may be substantially parallel relative to each other.

In some embodiments, the absorbent pad 300 may be configured to include another seam (not shown), which is configured to be an internal or external seam located at the perimeter edge opposite of the seam 305C. In this embodiment, the other seam (not shown) may be substantially perpendicular to the seams 305A and 305B, and may be substantially parallel to seam 305C. However, in other embodiments, no other seam may be located at the perimeter edge opposite of the of the seam 305C where the absorbent pad 300 may not be made from separate, individual pieces of fabric, but may instead be made of one continuous piece of fabric. In this embodiment, the absorbent pad 300 may be made by folding fabric onto itself such that a fold 310 is created at an opposite side of the seam 305C. In this manner, the fold 310 and the seam 305C may be substantially parallel relative to each other.

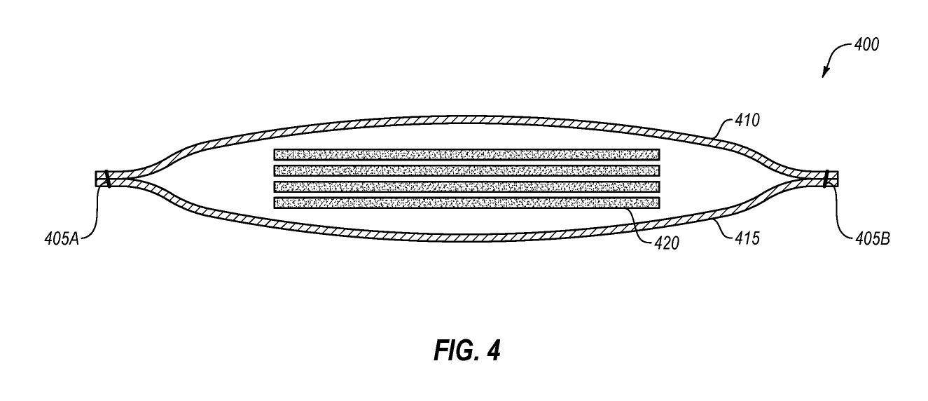

FIG. 4 illustrates a cross-section side view of an example absorbent pad 400 that may be configured to absorb moisture via absorbing layers 420. The absorbent pad 400 may include seams 405, a first padding layer 410, a second padding layer 415, and/or an absorbing layers 420. The absorbent pad 400 may be configured to be substantially the same as or analogous to the absorbent pad 225 and/or the absorbent pad 300.

In some embodiments, the absorbent pad 400 may be formed by the first padding layer 410 and the second padding layer 415. In some embodiments the first padding layer 410 and the second padding layer 415 may be made of one continuous piece of fabric, while in other embodiments separate pieces of fabric may be used to construct one or more portions of the absorbent pad 400, first padding layer 410, second padding layer 415, and the like. In some embodiments the first padding layer 410 and the second padding layer 415 may be made of fleece, in any variety of thicknesses such as micro, 100, 200, and 300 (micro being the thinnest and most flexible, and 300 being the thickest and least flexible). In some embodiments, the first padding layer 410 and the second padding layer 415 may be made with materials having substantially similar or analogous properties to fleece, which are known to those of ordinary skill in the art.

In some embodiments, the first padding layer 410 and the second padding layer 415 may not be configured to absorb moisture in relatively significant portions compared to the absorbing layers 420. Instead, in some embodiments the first padding layer 410 and the second padding layer 415 may be configured as padding, an additional spatial buffer between the animal and the absorbing layers 420, and/or an additional moisture wicking layer supplementing the wicking capability of the outer shell 105.

The seams 405, including seams 405A and 405B, may be configured to be substantially the same as or analogous to the seams 305A and 305B (of FIG. 3) respectively. In some embodiments, a combination of seams of the absorbent pad 400 may entirely enclose or at least partially enclose the absorbing layers 420 via at least the seam 305C (of FIG. 3) and/or the seams 405A and 405B.

In some embodiments the absorbing layers 420 may include a varying amount of layers configured to absorb moisture wicked away from the animal. In some embodiments, the amount of layers may be 2-4, 4-6, 6-8, 8-10, 10-15, and 15-20. The amount of layers in the absorbing layers 420 may directly correspond to an absorption capacity of the absorbing pad 400. For example, the absorbing layers 420 may be configured to have an absorption capacity of about 1 gallon of water for 4 layers or about 0.25 gallons of water per layer of the absorbing layers 420.

In some embodiments, the absorption capacity of the absorbing pad 400 may be greater than a maximum amount of retained moisture possible for the animal. If the absorption capacity is less than the maximum amount of retained moisture possible for the animal, moisture may accumulate in undesired places beyond the pet bed 100 and/or the animal may not be properly dried. The maximum amount of retained moisture possible for the animal may be dependent on or more factors, and/or combination of factors, such as wetness, size, shape, weight, breed, amount of fur of the animal, and the like. For example, a typical basset hound may have on average about 0.15 gallons to about 0.3 gallons of maximum retained moisture after a bath. Larger breeds for instance, may have a larger maximum amount of retained moisture possible, thereby necessitating a larger absorption capacity (e.g., more layers in the absorbing layers 420). One skilled in the art will appreciate, after reviewing this disclosure, that the absorbing pad 400 may have any desired absorption capacity depending, for example, upon the intended use of the pet bed.

In some embodiments, the absorbing layers 420 may be made of microfiber (e.g., microfiber terry), each layer of the absorbing layers 420 may have a thickness of about 1/16 inch to about ⅛ inch. In some embodiments, the absorbing layers 420 may be made with materials having substantially similar or analogous properties to microfiber, which are known to those of ordinary skill in the art.

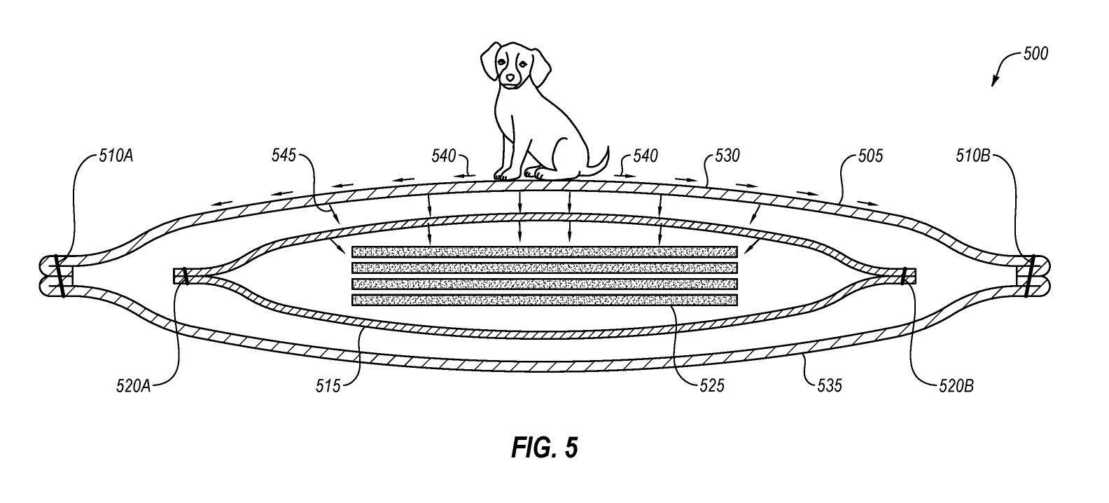

FIG. 5 illustrates a cross-section side view of an example pet bed 500 that may be configured to wick moisture away from the animal and/or allow moisture from the animal to flow in various directions for absorption. The pet bed 500 may include an outer shell 505, outer shell seams 510A and 510B, an absorbent pad 515, seams 520A and 520B, absorbing layers 525, a top face 530, a bottom face 535, a horizontal water flow 540, and/or a vertical water flow 545.

The outer shell 505 may be configured to be substantially the same as or analogous to the outer shell 105 and 205. The outer shell seams 510, such as seams 510A and 510B, may be configured to be substantially the same as or analogous to the outer shell seams 210. The seams 520, which may include seams 520A and 520B, may be configured to be substantially the same as or analogous to the seams 305A, 405A, 305B, and/or 405B. The absorbing layers 525 may be configured to be substantially the same as or analogous to the absorbing layers 420. The top face 530 and the bottom face 535 may be configured to be substantially the same as or analogous to the top face 215 and the bottom face 220, respectively.

In some embodiments a horizontal water flow 540 and a vertical water flow 545 may occur when the animal (which is wet) is positioned on top of the pet bed 500. The horizontal water flow 540 may travel in a substantially horizontal fashion so as to follow the surface of the outer shell 505, which in FIG. 5 would be the top face 530. In some embodiments, this effect may occur due to hydrophobic properties of the outer shell 505. In some embodiments, the horizontal water flow 540 may spread moisture over a greater surface area of the outer shell 505, and in turn may provide for more even distribution of moisture to the absorbing layers 525. In this manner, the hydrophobic properties of the outer shell 505 may lessen concentrated distributions of the vertical water flow 545. In some embodiments, this effect may in turn decrease a drying time of the animal and/or the pet bed 500. Thus, in some embodiments, moisture absorbed in the absorbing layers 525 may be from at least two portions of moisture: (i) that which came directly from the animal in a substantially vertical manner from the animal, through the outer shell 505, and into the absorbing layers 525 and (ii) that which traveled from the animal, onto the outer shell 505, substantially horizontally across a portion of the outer shell, then substantially vertically through the outer shell 505, and into the absorbing layers 525.

In some embodiments where the maximum amount of retained moisture possible for the animal may be discharged onto the pet bed 500 from the animal at a rapid rate, some of the moisture may bead up and roll off of the pet bed 500 entirely or simply wrap underneath and follow the bottom face 535. In either situation, in these embodiments capillary action may be provided by the outer shell 505 and this may wick moisture from a ground surface (provided there is contact between the outer shell 505 and the ground surface) and/or the bottom face 535. This moisture may then be absorbed into the absorbing layers 525 such that the moisture will have traveled substantially upward (opposite of gravity's pull) from the bottom face 535 and into the absorbing layers 525.

In some embodiments, the wicking capability of the outer shell 505 may be independent of whether the top face 530 or the bottom face 535 faces upward (e.g., in direct contact with the animal). Thus, caretakers, owners, and/or groomers may from time to time (or at some particular time interval) flip the pet bed 500, and this may not result in any loss of functionality.

One skilled in the art will appreciate that, for this and other processes, operations, and methods disclosed herein, the functions and/or operations performed may be implemented in differing order. Furthermore, the outlined functions and operations are only provided as examples, and some of the functions and operations may be optional, combined into fewer functions and operations, or expanded into additional functions and operations without detracting from the essence of the disclosed embodiments.

In accordance with common practice, the various features illustrated in the drawings may not be drawn to scale. The illustrations presented in the present disclosure are not meant to be actual views of any particular apparatus (e.g., device, system, etc.) or method, but are merely idealized representations that are employed to describe various embodiments of the disclosure. Accordingly, the dimensions of the various features may be arbitrarily expanded or reduced for clarity. In addition, some of the drawings may be simplified for clarity. Thus, the drawings may not depict all of the components of a given apparatus (e.g., device) or all operations of a particular method.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms “first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

What is claimed is:

1. A pet bed comprising:
an outer shell configured to wick moisture away from an animal such that, after a period of time, one or more portions of the animal in contact with the outer shell have less retained moisture than a maximum amount of retained moisture possible for the portions of the animal in contact with the outer shell, the outer shell including hydrophobic properties that permit a horizontal flow of moisture across a portion of the outer shell, the horizontal flow of moisture lessening a concentration of a vertical flow of moisture;
an absorbent pad disposed within the outer shell, the absorbent pad comprising:
a first padding layer and a second padding layer; and
four or more absorbing layers positioned between the first padding layer and the second padding layer, each layer of the four or more absorbing layers having a thickness of about 1/16 inch to about ⅛ inch and configured to absorb the moisture wicked away from the animal;
wherein the absorbent pad has an absorption capacity of about 0.25 gallons per each layer of the four or more absorbing layers.

2. The pet bed of claim 1, wherein the first padding layer and the second padding layer are sewn together at a perimeter edge such that there are three or more external seams.

3. The pet bed of claim 1, wherein the top face of the outer shell and the bottom face of the outer shell are sewn together at a perimeter edge such that there is only one external seam.

4. The pet bed of claim 1, wherein when the maximum amount of retained moisture possible for the portions of the animal increases, the four or more absorbing layers also increases in number in order for the absorption capacity to remain greater than the maximum amount of retained moisture.

5. The pet bed of claim 4, wherein the four or more absorbing layers are made of microfiber terry.

6. The pet bed of claim 1, wherein wicking moisture includes wicking a first portion of moisture configured to be only the vertical flow of moisture traveling from the animal, through the outer shell, through the first padding layer, and then into one or more of the four or more absorbing layers in a gravitational downward fashion, and wherein wicking moisture includes wicking a second portion of moisture configured to be both the horizontal flow of moisture and the vertical flow of moisture traveling from the animal, onto the outer shell, substantially horizontally across the portion of the outer shell, then substantially vertically through the outer shell, through the first padding layer, and into one or more of the four or more absorbing layers.

7. The pet bed of claim 1, wherein the first padding layer and the second padding layer are made of polyester microfleece.

8. The pet bed of claim 1, wherein the outer shell is made of a wicking fabric, and wherein the absorbing pad and the outer shell are substantially concentric.

9. A pet bed comprising:
an outer shell configured to wick moisture away from an animal such that, after a period of time, portions of the animal in contact with the outer shell have less retained moisture than a maximum amount of retained moisture possible for the portions of the animal in contact with the outer shell, the outer shell including hydrophobic properties that permit a horizontal flow of moisture across a portion of the outer shell, the horizontal flow of moisture lessening a concentration of a vertical flow of moisture;
an absorbent pad disposed within the outer shell, the absorbent pad comprising:
a first padding layer and a second padding layer; and
four or more absorbing layers positioned between the first padding layer and the second padding layer, each layer of the four or more absorbing layers configured to absorb the moisture wicked away from the animal;
wherein the absorbent pad has an absorption capacity of about 0.25 gallons per each layer of the four or more absorbing layers.

10. The pet bed of claim 9, wherein a capability to wick moisture away from the animal is independent of whether a top face of the outer shell or a bottom face of the outer shell is in contact with the animal, the capability being the same for both the top face and the bottom face.

11. The pet bed of claim 9, wherein the pet bed is configured to be reused.

12. The pet bed of claim 9, wherein the pet bed is configured to be washed in a washing machine.

13. The pet bed of claim 9, wherein a size and a shape of the pet bed is compatible with the size and the shape of the animal, the shape of the pet bed configured to be rectangular such that a first set of opposing sides is shorter in length than a second set of opposing sides, the first set of opposing sides and the second set of opposing sides being perpendicular relative to each other.

14. The pet bed of claim 1, wherein the first padding layer and the second padding layer are sewn together at a perimeter edge such that there are three or more external seams.

15. The pet bed of claim 10, wherein the top face of the outer shell and the bottom face of the outer shell are sewn together at a perimeter edge such that there is only one external seam.

16. The pet bed of claim 9, wherein when the maximum amount of retained moisture possible for the portions of the animal increases, the four or more absorbing layers also increases in number in order for the absorption capacity to remain greater than the maximum amount of retained moisture.

17. The pet bed of claim 16, wherein the four or more absorbing layers are made of microfiber terry.

18. The pet bed of claim 9, wherein wicking moisture includes wicking a first portion of moisture configured to be only the vertical flow of moisture traveling from the animal, through the outer shell, through the first padding layer, and then into one or more of the four or more absorbing layers in a gravitational downward fashion, and wherein wicking moisture includes wicking a second portion of moisture configured to be both the horizontal flow of moisture and the vertical flow of moisture traveling from the animal, onto the outer shell, substantially horizontally across the portion of the outer shell, then substantially vertically through the outer shell, through the first padding layer, and into one or more of the four or more absorbing layers.

19. The pet bed of claim 9, wherein the first padding layer and the second padding layer are made of polyester microfleece.

20. The pet bed of claim 9, wherein the outer shell is made of a wicking fabric, and wherein the absorbing pad and the outer shell are substantially concentric.
